(19) United States
(12) Patent Application Publication
(10) Pub. No.: US 2007/0274316 A1
(43) Pub. Date: Nov. 29, 2007

(54) Method For Switching A Communication Connection From A First Connection Path To A Second Connection Path

(76) Inventors: Alfons Fartmann, Garching (DE); Karl Klaghofer, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/660,640

(22) PCT Filed: Aug. 17, 2005
(86) PCT No.: PCT/EP05/54046

§ 371 Date: Feb. 20, 2007

(30) Foreign Application Priority Data
Aug. 24, 2004 (DE) 10 2004 041 015.1

(51) Int. Cl. H04L 12/56

(52) U.S. Cl. 370/392

(57) ABSTRACT

There are described packets transmitted via the first connection path comprise a first packet propagation time. Said packets are temporarily stored in a first intermediate memory of a receiver unit. The packets transmitted via the second connection path comprise a second packet propagation time and are temporarily stored in a second intermediate memory of the receiver unit. All packets stored in the first step in the first intermediate memory are emitted. Subsequently, packets stored in the second intermediate memory are emitted. According to a first embodiment, each x^{th} packet stored in the second intermediate memory is rejected. According to a second embodiment, the output of the packets stored in the second intermediate memory is carried out in a compressed manner.

### CROSS REFERENCE TO RELATED APPLICATIONS

This application is the US National Stage of International Application No. PCT/EP2005/054046, filed Aug. 17, 2005 and claims the benefit thereof. The International Application claims the benefits of German application No. 10 2004 041 015.1 DE filed Aug. 24, 2004, both of the applications are incorporated by reference herein in their entirety.

### FIELD OF INVENTION

The present invention relates to a method for switching a packet-oriented communication connection between a receiver unit and a transmitter unit from a first connection path to a second, shorter connection path, in which the packets transmitted over the first connection path have a first packet propagation time and are temporarily stored in a first intermediate memory of the receiver unit and the packets transmitted over the second connection path have a second packet propagation time and are temporarily stored in a second intermediate memory of the receiver unit. In addition, the invention relates to a receiver unit for carrying out said method.

### BACKGROUND OF INVENTION

Because of an increasing global alignment of companies, the use of telecommunication services for the transmission of speech and data is increasing all the time. The result is an ongoing increase in costs arising from these telecommunication services and this becomes a considerable cost factor for the companies, who then look for options for reducing these costs. Global packet-oriented communication networks such as the Internet offer one possibility whereby it is possible to be able to transmit data cost-effectively and worldwide.

In such types of packet-oriented real-time communication systems there are scenarios in which an active communication connection between two units connected to the packet-oriented communication network has to be replaced by a new communication connection via a new path. The reasons for this could for example be as follows:
a) Mobility scenarios such as for example a handover in the case of mobile terminal devices, for example, WLAN terminal devices;
b) Quality problems or even a failure of the communication network in the existing connection path;
c) Switching to a more cost-effective connection path; or
d) Optimizing the connection path, for example with regard to the number of network nodes to be traversed in the connection path—often referred to as transit nodes or hops in the literature—or the reduction of an existing end-to-end delay—referred to as a ‘delay’ in the literature.

A method which makes possible the transmission of data to be transmitted within the framework of a voice connection via a computer network such as for example the Internet, is known from the US patent U.S. Pat. No. 6,751,210.

### SUMMARY OF INVENTION

It is known that in cases in which, within the framework of a real-time critical transmission of voice data via the computer network, it is no longer possible to ensure a sufficient transmission quality, a new connection can be established via an alternative communication network—for example an ISDN-oriented communication network (Integrated Services Digital Network) and the data to be transmitted via this new connection is subsequently transmitted via said new connection.

On the transmitter side, for the unit involved in the communication connection as a function of the present scenario of the connection protocol used—for example the SIP protocol, the H.323 protocol or other proprietary protocols—and/or other criteria, there is a defined switching point from which the data to be transmitted—for example voice packets—is sent via the new connection path. A packet N is thus still transmitted over the old existing connection path, but the packet N+1 is already being transmitted over the new connection path.

In cases in which the new connection path is “shorter” than the old connection path, it is highly probable on the receiver side, for the unit involved in the communication connection, that on the arrival of the first packets via the new connection path, packets will still be located in the intermediate memory—often referred to as a jitter buffer in the literature—of the old connection path or are even still being transmitted over the old connection path, i.e. have not yet arrived at the receiver unit.

The scenario described above is explained in detail below on the basis of the two accompanying drawings, namely FIG. 1 and FIG. 2:

An object of the present invention is therefore to specify a method and a unit for receiving the data packets, by means of which the problems described above can be eliminated.

The object of the invention is achieved with regard to the method and with regard to the unit for receiving the data packets by the features of the independent claims

According to the invention, the packets transmitted via a first connection path have a first packet propagation time, in which said packets are temporarily stored in a first intermediate memory of a receiver unit. The packets transmitted via a second connection path have a second packet propagation time which is shorter compared with a first packet propagation time and are temporarily stored in a second intermediate memory of the receiver unit. In this case packet propagation time means the length of time between transmission of the packets at the transmitter unit and output of the packets at the receiver unit.

After a switch from a first connection path to a second connection path, all the packets stored in the first step in the first intermediate memory are output or forwarded. Only subsequently are the packets stored in the second intermediate memory output, whereby, according to a first embodiment of the invention, each n^{th} packet stored in the second intermediate memory is discarded.

According to a second embodiment of the invention, the packets stored in the second intermediate memory are output compressed, i.e. more quickly than under normal circumstances.

An important advantage of the method according to the invention is that the method can even be implemented in existing systems in a simple manner.

Further advantageous embodiments of the invention are defined in the subclaims.

According to a further embodiment of the invention, the data packets are stored in a second intermediate memory until the time between a transmission of the packets at the transmitter unit and an output of the packets at the receiver unit essentially matches the second packet propagation time.

Likewise, according to a further embodiment of the invention, the data packets stored in the second intermediate memory are output compressed until the time between a transmission of the packets at the transmitter unit and an output of the packets at the receiver unit essentially matches the second packet propagation time.

One of the advantages of the embodiments of the invention defined in the subclaims is that it is possible to use the method independently from the connection control protocol used in the packet-oriented communication network—for example, the SIP (Session Initiation Protocol), the H.323 protocol or another proprietary protocol.

### BRIEF DESCRIPTION OF THE DRAWINGS

Examples of embodiments of the invention are shown and explained below with reference to drawings.

These drawings are as follows:

FIG. 1: a structural diagram for the schematic representation of the major functional units involved in the method according to the invention before a switch is made from a first connection path to a second connection path;

FIG. 2: a structural diagram for the schematic representation of the scenario after the switch is made from a first connection path to a second connection path according to the prior art; and

FIG. 3: a structural diagram for the schematic representation of the scenario according to the invention after the switching is made from a first connection path to a second connection path.

### DETAILED DESCRIPTION OF INVENTION

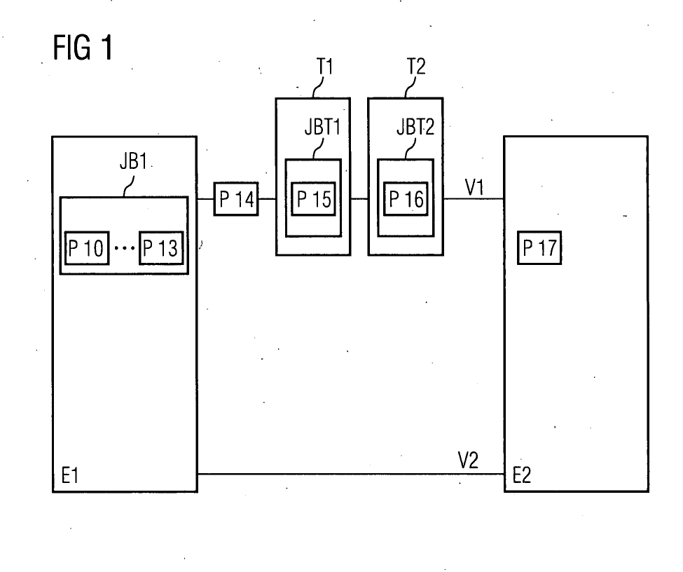

FIG. 1 shows a receiver unit E1 and a transmitter unit E2 which are connected to each other via a first connection path V1 and a second connection path V2. The scenario depicted relates to the transmission of packets—in particular packets containing voice data—before a switch is made from the first connection path V1 to a second connection path V2. The connection paths V1 and V2 relate to connection paths via a packet-oriented communication network, in particular the Internet or an intranet. In this case, both the receiver unit and the transmitter unit E1, E2 are for example implemented by terminal devices, gateways, servers, etc.

The first connection path V1 runs via two transit nodes T1 and T2, whereas on the other hand the second connection path V2 directly connects both the receiver unit and the transmitter unit E1, E2 to each other. This means that the second connection path V2 is “shorter” than the first connection path V1.

At the point in time depicted, the packets P10, . . . , P13 are temporarily stored in a first jitter buffer JB1 of the receiver unit E1 allocated to the connection path V1, a packet P15 in a jitter buffer JBT1 of the first transit node T1 and a packet P16 in a jitter buffer JBT2 of the second transit node T2. In addition, a packet P14 is transmitted between the first transit node T1 and the receiver unit E1 and a packet P17 is ready in the transmitter unit E2 for a transmission via the first connection path V1.

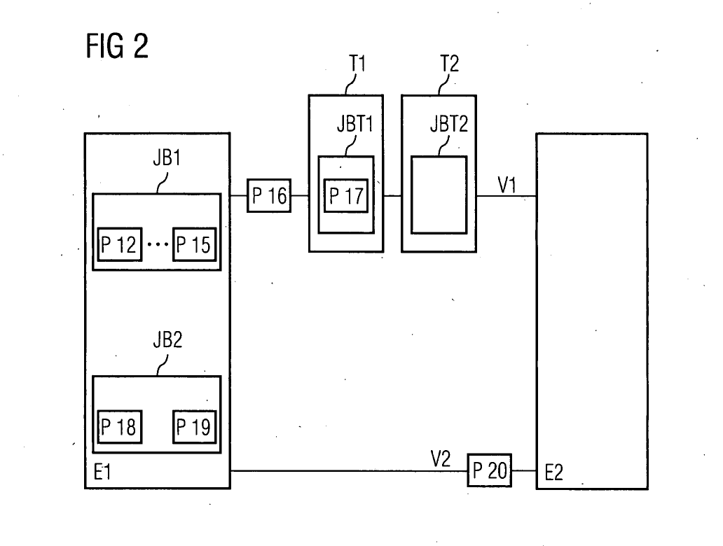

FIG. 2 shows the scenario described in connection with FIG. 1 after a switch from a first connection path V1 to a second connection path V2 so that the packets P18, . . . ,P20 are or were already transmitted over the second connection path V2.

In the meantime, the packets P12, . . . ,P15 are temporarily stored in a first jitter buffer JB1 of the receiver unit E1. The original packet P16 that was temporarily stored in a jitter buffer JBT2 of the second transit node T2 is now transmitted between the first transit node T1 and the receiver unit E1. The original packet P17 that is ready in the transmitter unit E2 for a transmission via the first connection path V1 is temporarily stored in a jitter buffer JBT1 of the first transit node T1.

In addition, the packets P18 and P19 have already been stored temporarily in a second jitter buffer JB2 of the receiver unit El allocated to the second connection path V2. By doing so, it is possible that the first jitter buffer JB1 and the second jitter buffer JB2 can also be implemented as a common memory, in which the packets allocated to the first connection path V1 and the second connection path V2 are temporarily stored in different areas of the memory. A packet P20 is now transmitted between the transmitter unit E2 and the receiver unit E1.

Thus at the point in time when the first packets P18, P19 arrive via the new second connection path V2, the packets P12, . . . ,P15 are still located in a first jitter buffer JB1, which were transmitted over the old first connection path V1 or it is even possible that the packets P16, P17 are still being transmitted over the old first connection path V1.

In the receiver unit E2, the following two possibilities are available for switching from a first connection path V1 to the second connection path V2.

According to a first possibility, switching takes place at the point in time when the first packet P18 arrives at the receiver unit E1 via the second connection path V2. However, this means that the packets P12, . . . ,P15 which are still temporarily stored in a first jitter buffer JB1 and the packets P16, P17 still presently being transmitted over the first connection path V1 are rejected. This leads to noticeable speech gaps—often referred to as “speech clipping” in the literature.

According to a second possibility, it is still possible to output all the packets P12, . . . ,P15 that are temporarily stored in a first jitter buffer JB1 and those packets P16, P17 that are still presently transmitted over the first connection path V1 to the relevant subscriber. In the meantime, the packets P20, . . . received over the second connection path V2 are temporarily stored in a second jitter buffer JB2. Only after the output of the last packet P17 received over the first connection path V1, the packets P18, P19 stored in a second jitter buffer JB2 are emitted. However, this means that the end-to-end delay for the transmission of data between the transmitter unit and the receiver unit E2, E1 is not improved and, for this reason, the actual objective of the switching is not achieved.

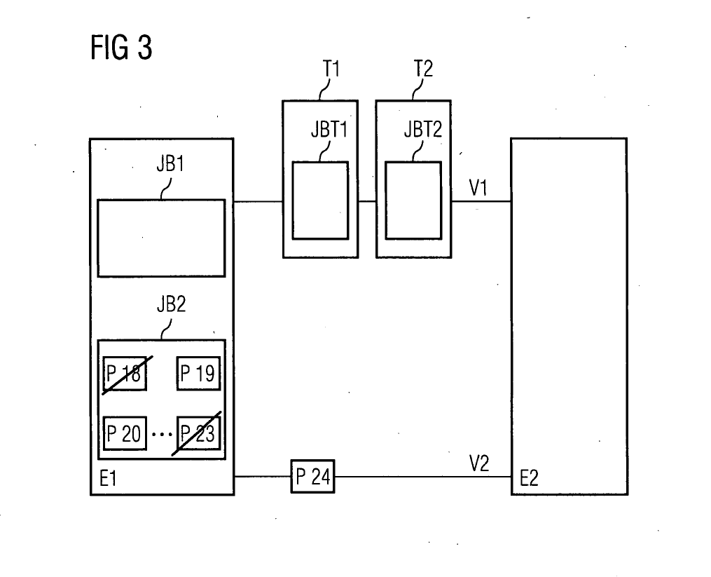

FIG. 3 shows the scenario described in connection with FIG. 1 and FIG. 2 after a switch from a first connection path V1 to a second connection path V2, in which all the packets P10, . . . ,P17 temporarily stored in a first jitter buffer JB1 are output. At present, the packets P18, . . . ,P23 are temporarily stored in a second jitter buffer JB2. In addition, a packet P24 is transmitted over the second connection path V2 between the transmitter unit and the receiver unit E2, E1.

In the case of the scenario described, the second connection path V2, is “shorter” than the first connection path V1, i.e. the packet propagation time—which is the time between a transmission of the packets at the transmitter unit E2 and an output of the packets at the receiver unit E1—over the second connection path V2 is shorter than the packet propagation time over the first connection path V1.

Based on the fact that the packets P18, . . . ,P23 temporarily stored in a second jitter buffer JB2 are only output at the point in time when the packets are no longer stored in a first jitter buffer JB1, the packet propagation time of the packets P18, . . . ,P24 transmitted over the second connection path V2 essentially corresponds to the packet propagation time of the packets P10, . . . ,P17 transmitted over the first connection path V1.

To reduce the packet propagation time of the packets P18, . . . transmitted over the second connection path V2, the following two possibilities are proposed according to the invention:

According to a first possibility, each n^{th} (n is a whole-numbered, natural number) packet P18, . . . ,P23 temporarily stored in a second jitter buffer JB2 is rejected. In the present example of an embodiment, the packets P18, P23, . . . (illustrated in the drawing by the packets with a diagonal line through them) are rejected so that n=5, i.e. that each 5^{th} packet is rejected.

The packets P18, . . . ,P23 temporarily stored in a second jitter buffer JB2 are discarded in this case until the time between a transmission of the packets at the transmitter unit E2 and an output of the packets at the receiver unit E1 in essence, corresponds to the packet propagation time via the second connection path V2.

Therefore, the option described relates to a controlled packet loss carried out in a manner that is hardly noticeable to a subscriber.

According to a second option, which is not shown here, the packets P18, . . . ,P23 temporarily stored in a second jitter buffer JB2 are output compressed, i.e. the packets are output quicker than it is possible to provide the said packets. In this case, said packets P18, . . . ,P23 temporarily stored in a second jitter buffer JB2 are again output compressed manner until the time between a transmission of the packets at the transmitter unit E2 and an output of the packets at the receiver unit E1 essentially corresponds to the packet propagation time via the second connection path V2.

In this case, the compressed output can be carried out in the same way as proposed in the German patent application with the file reference number 103 27 057. Likewise, it is possible for such a compressed output of the packets to be carried out in a manner that is barely perceptible to a subscriber.

Using the two methods described, it is possible in a simple manner for the existing output delay for the packets P18, . . . ,P23 temporarily stored in a second jitter buffer JB2 to “catch up” in a way that is barely perceptible to a relevant subscriber.

1-9. (canceled)

10. A method for switching a packet-oriented communication connection between a receiver unit and a transmitter unit from a first connection path to a second shorter connection path, comprising:
storing a first packet propagation time in a first intermediate memory of the receiver unit, the first packet propagation time based upon a packet transmission via the first connection path;
storing a second packet propagation time in a second intermediate memory of the receiver unit, the second packet propagation time based upon a packet transmission via the second connection path;
outputting the packets stored in the first intermediate memory,
after outputting the packets stored in the first intermediate memory outputting the packets stored in the second intermediate memory; and
discarding selected packets stored in the second intermediate memory.

11. The method as claimed in claim 10, wherein all the packets stored in the first intermediate memory are outputted.

12. The method as claimed in claim 10, wherein each n^{th} packet stored in the second intermediate memory is selected and discarded.

13. The method as claimed in claim 10, wherein the packets stored in the second intermediate memory are discarded until the time between a transmission of the packets at the transmitter unit and an output of the packets at the receiver unit matches the second packet propagation time.

14. The method as claimed in claim 12, wherein n is an integer, natural number.

15. The method as claimed in claim 10, wherein the first intermediate memory of the receiver unit and the second intermediate memory of the receiver unit are embodied as a common memory.

16. The method as claimed in claim 13, wherein the receiver unit matches the second packet propagation time at least essentially.

17. A method for switching a packet-oriented communication connection between a receiver unit and a transmitter unit from a first connection path to a second, shorter connection path, comprising:
storing a first packet propagation time in a first intermediate memory of the receiver unit, wherein the first packet propagation time is based upon a packet transmission via the first connection path;
storing a second packet propagation time in the second intermediate memory of the receiver unit, wherein the second packet propagation time is based upon a packet transmission via the second connection path;
outputting the packets stored in the first intermediate memory, and
after outputting the packets stored in the first intermediate memory compressed outputting the packets stored in the second intermediate memory.

18. The method as claimed in claim 17, wherein all the packets stored in the first intermediate memory are outputted.

19. The method as claimed in claim 17, wherein the packets stored in the second intermediate memory are outputted compressed until the time between a transmission of the packets at the transmitter unit and an output of the packets at the receiver unit matches the second packet propagation time.

20. The method as claimed in claim 19, wherein the receiver unit matches the second packet propagation time at least essentially.

21. The method as claimed in claim 17, wherein the packet-oriented communication connection is established over the Internet or an Intranet.

22. The method as claimed in claim 17, wherein the connection control protocol for the communication connection is a SIP protocol.

23. The method as claimed in claim 17, wherein the connection control protocol for the communication connection is a H.323 protocol.

24. The method as claimed in claim 17, wherein the first intermediate memory of the receiver unit and the second intermediate memory of the receiver unit are embodied as a common memory.
